(19) United States
(12) Patent Application Publication
(10) Pub. No.: US 2004/0266395 A1
(43) Pub. Date: Dec. 30, 2004

(54) Process for securing a mobile terminal and applications of the process for executing applications requiring a high degree of security

(76) Inventors: Jean-Claude Pailles, Epron (FR); Patrick Remery, Caen (FR)

Correspondence Address: BACHMAN & LAPOINTE, P.C., 900 CHAPEL STREET, SUITE 1201, NEW HAVEN, CT, 06510, US

(21) Appl. No.: 10/830,761

(22) Filed: Apr. 23, 2004

(30) Foreign Application Priority Data
Apr. 23, 2003 (FR) 0304974

(51) Int. Cl. H04B 1/38; H04M 1/00

(52) U.S. Cl. 455/411; 455/410; 455/558

(57) ABSTRACT

A method for making a telecommunication terminal secure when it is connected to a terminal user identification module. The method including execution of a matching procedure in which the terminal transmits terminal identification information to the identification module connected to the terminal, and the identification module compares the identification information received from the terminal with terminal identification information stored in a memory, transmits the result of the comparison to the terminal, and if the identification information stored by the identification module corresponds to the information for the terminal, it sets an internal matching indicator (LOCK) indicating that the terminal has been identified by the identification module.

### BACKGROUND OF THE INVENTION

The invention relates to a method for securing a user's communication terminal.

It is particularly but not exclusively applicable to mobile telecommunication terminal designed to hold a secure user authentication module. For example, this type of mobile terminal complies with the GSM (Global System for Mobile communications) standard or the UMTS (Universal Mobile Telecommunication System) standard. More generally, it is also applicable to any mobile terminal comprising a telecommunication module designed to receive such an authentication module.

Many applications using a public data transmission network such as the Internet network, require that the user should be remotely authenticated. This type of application requires determining whether or not a user's right exists or authenticating information supplied by him, or that the network should transmit confidential information to a clearly identified user.

These operations require that the user must be identifiable in a reliable and secure manner. This is usually done using an electronic device such as a smart card or an authentication or security token that stores keys and is capable of executing cryptographic procedures, particularly identification procedures to prove that he holds a key, or to decrypt a confidential message.

Mobile telephones, particularly GSM type telephones, usually contain an identification module in the form of a smart card called a SIM (Subscriber Identification Module) card that identifies the owner of the mobile telephone with the telephony network. In order to be able to use his mobile telephone, the user must input a confidential code that is verified by the SIM identification module. The SIM identification module is provided with the cryptographic functions mentioned above for this purpose. Therefore, it can be used in an application involving the generation of an electronic signature, for example related to the terms of a transaction between a service provider and the mobile telephone user, knowing that the user has previously been authenticated by his mobile telephone by inputting his confidential code or a confidential code dedicated to the signature generation function and that this confidential code is checked by the identification module.

In e-commerce applications, it is essential that the service provider can recognize and trust such a signature, so that the user cannot contest a transaction by claiming that he never carried out this transaction and he has never (deliberately or otherwise) supplied his confidential code to a third party, or signed another different transaction.

The SIM identification module can also be used in an application to transmit a confidential message. When an encrypted message is received, the SIM card can calculate the received message decryption key to enable the mobile telephone to decrypt and display the message in plain text.

In this type of application, the message sender must also be certain that his message has been sent to the chosen addressee's terminal and that only the addressee will be able to decrypt it.

However, it is found that the security available with the SIM card is not sufficient in itself to provide convincing security, particularly now that third generation mobile telephones have appeared, in other words with the capability of receiving and containing several applications issued by different service providers. In this context, it is impossible to make sure that the mobile terminal used does not detect any defects, viruses or Trojan horses that, for example, could resend an encrypted message to another terminal.

Therefore, it has been found necessary to remotely demonstrate that the mobile terminal+the software loaded in it has maintained all its integrity and has the required security qualities.

For this purpose, the mobile terminal can protect itself from viruses and Trojan horses by refusing to download new applications unless it can authenticate their source and integrity, or if this is not the case, by confining them such that they cannot in anyway modify the terminal assembly. It is also necessary to provide an authentication function enabling remote service providers to check that the mobile terminal actually has the required security qualities.

The SIM card is not capable itself of providing such an authentication function since it is removable and can be installed in any terminal.

Moreover, there is no question of preventing a user from being able to use the same SIM card with different mobile terminals, particularly so that he can use different terminals.

### SUMMARY OF THE INVENTION

The purpose of this invention is to eliminate these disadvantages. This purpose is achieved by providing a method for making a telecommunication terminal secure when it is connected to a terminal user identification module.

According to the invention, this method includes a step for execution of a matching procedure in which:

the terminal transmits terminal identification information to the identification module connected to the terminal,

the identification module compares the identification information received from the terminal with terminal identification information stored in a memory, and transmits the result of the comparison to the terminal,

if the identification information stored by the identification module corresponds to the identification information stored by the terminal, it sets an internal matching indicator indicating that the terminal has been identified by the identification module

if the internal matching indicator is not set by the identification module, the terminal prevents execution of procedures requiring a high degree of security, installed in the terminal, the other functions of the terminal remaining accessible.

Advantageously, the matching procedure is run every time that the terminal is switched on.

According to one particular feature of the invention, if the identification information stored by the identification module does not correspond to the terminal information, the terminal triggers a procedure to update the identification information stored by the identification module, in which the identification module previously authenticates an authority authorized to perform this update, and if the authentication is successful, the identification module memorizes the received terminal identification information and sets the internal matching indicator.

Preferably, the identification module memorizes identification information for several terminals.

Also preferably, a list or a sequence of terminal identification information is registered in the memory of the identification module when it is submitted to the user.

According to another feature of the invention, this method comprises execution of a procedure to update the list or sequence of terminal identification information memorized by the identification module, performed through a data transmission network by an authorized authority, this procedure comprising a step to authenticate the authority authorized by the identification module.

Advantageously, the terminal identification information comprises terminal profile information.

Preferably, read access to terminal identification information stored by the identification module is protected either by a password or by an active signature procedure, in order to prevent matching of the identification module to an unapproved terminal.

According to yet another particular feature of the invention, a procedure requiring a high degree of security is only executed following a step in which the user inputs a confidential code on the terminal, the identification module checks this confidential code, and a procedure requiring a high degree of security is not executed unless the confidential code input by the user is correct.

Preferably, procedures requiring a high degree of security include a procedure for generating an electronic signature.

According to another particular feature of the invention, procedures requiring a high degree of security include a procedure for reception and decryption of an encrypted message using a secret key memorized by the identification module.

According to another particular feature of the invention, procedures requiring a high degree of security include a procedure for authorization of access to contents stored in the terminal memory, each content being associated with access authorization levels as a function of content access modes, an access authorization level being assigned to each terminal user, the access procedure giving a user access to a requested content for an access mode specified by the user only if the user has an access authorization level corresponding to the specified access mode for the requested content.

According to yet another particular feature of the invention, some of the contents stored in the terminal memory are associated with a license stored by the identification module or transmitted to the identification module by the terminal, the license being checked by the identification module in order to decide whether or not to authorize access to the associated content.

The invention also relates to a telecommunication terminal, possibly of the mobile terminal type, comprising means of connecting to an identification module, and of implementing the method according to the invention defined above.

Advantageously, the identification module is a chip card, the connection means including a connector for a chip card.

The invention also relates to an identification module for a telecommunication terminal, for example a chip card, comprising means of connecting to terminal, and means of implementing the method according to the invention defined above.

### BRIEF DESCRIPTION OF THE DRAWINGS

One preferred embodiment of the invention will be described below as a non-limitative example, with reference to the attached drawings among which:

FIG. 1 illustrates a procedure for matching the mobile terminal and the smart card according to the invention, in the form of a processing sequence diagram;

FIG. 2 illustrates a procedure for signing a transaction according to the invention, in the form of a processing sequence diagram;

FIG. 3 illustrates a procedure for reception of an encrypted message according to the invention, in the form of a processing sequence diagram;

FIG. 4 illustrate a procedure for accessing a content memorized by the mobile terminal according to the invention, in the form of a processing sequence diagram.

### DETAILED DESCRIPTION OF THE PREFERRED EMBODIMENT(S)

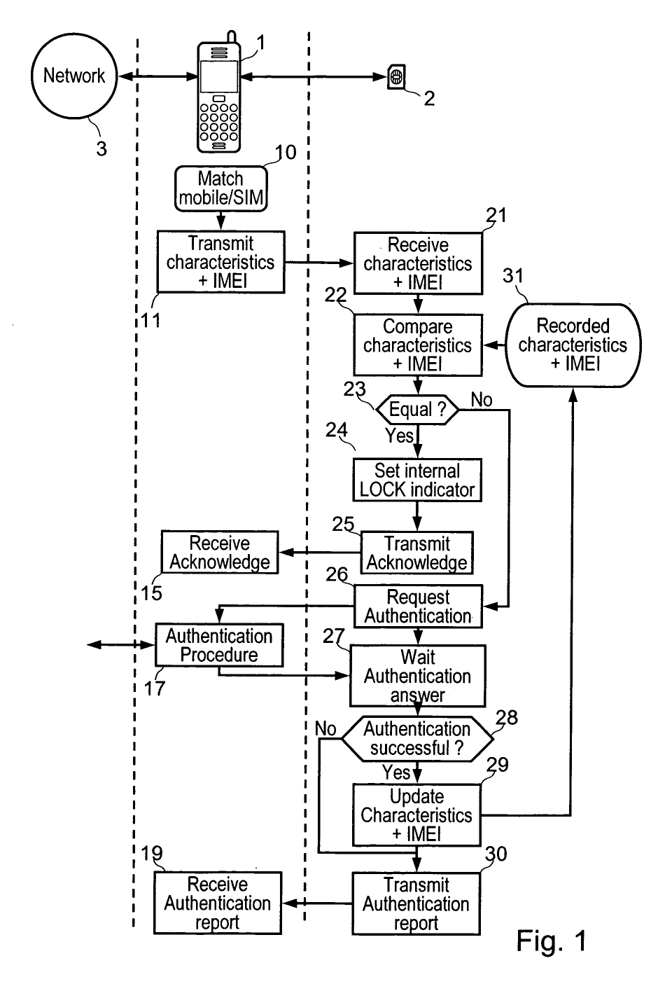

In FIG. 1, the method according to the invention is, implemented by mobile terminal 1 designed to communicate with other telecommunication terminal through a telephony network 3. To enable the operator of the network 3 to identify a user of such a mobile terminal 1, this mobile terminal includes a removable identification device 2, for example such as a chip card or a microprocessor card, and connection means for connecting to such a card. In a GSM or UMTS mobile network, this identification device is called the “subscriber identification module” (SIM).

Each mobile terminal 1 is identified by an identification number that is stored in a memory in the terminal. In GSM and UMTS standards, this mobile terminal identification number is called the IMEI (International Mobile Terminal Identity).

According to the invention, each mobile terminal 1 and each identification module 2 is programmed to execute a matching procedure, consisting for the identification module of requesting the mobile terminal to which it is connected to provide its identification number IMEI, to check that this number corresponds to a mobile terminal identification number stored by the identification module, and to send a report of this check to the mobile terminal.

If the identification module 2 has recognized the mobile terminal to which it is connected, it sets an internal indicator that means that the mobile terminal is deemed to be safe and can be used for a sensitive application.

The matching procedure illustrated in FIG. 1 is executed when the mobile terminal is switched on. This procedure firstly includes a step 11 in which the mobile terminal 1 transmits terminal characteristics to the identification module 2 and particularly the IMEI terminal identification number. In step 21, the identification module receives this information and compares it with the corresponding information 31 that it has previously recorded, in step 22. In the next step 23, if this information is identical to previously recorded information, the identification module sets an internal indicator called LOCK in step 24, and sends an acknowledgement message (step 25) to the mobile terminal, which receives this message in step 15.

If the mobile terminal identification information received in step 23 is not identical to that recorded by the identification module, the identification module triggers an authentication procedure 17 on the mobile terminal. This authentication procedure may consist of inputting a single password using the mobile terminal keyboard that is transmitted and checked in step 27 by the identification module. If the authentication is successful (step 28), the identification module updates its memory 31 in step 29 with the identification information that was transmitted by the mobile terminal in step 21, sets the LOCK indicator and sends an authentication successful report to the mobile terminal in step 30. Otherwise, it sends a failure report in step 30.

The mobile terminal receives this report message in step 19.

It would be possible for the identification module 2 to save the identification information for several mobile terminals, so as to authorize the user to use several different terminals, for example an ultra lightweight mobile terminal and a communicating personal data assistant (PDA).

It would also be possible to save identification information for several mobile terminals in the identification module 2 when it is handed over to the user, to automate the matching procedure. Thus, the identification information 31 stored by the module 2 can be in the form of a list of recognized mobile terminal identification numbers approved in terms of security, or sequences of such numbers.

The matching information 31 stored by the identification module can then be updated by the operator of the mobile network who can send this information through the network 3 to the mobile terminal 1, to be used by the identification module. This information may be updated remotely through the network 3, by an approved authority (network operator 3 or an authority responsible for approval of mobile terminal) using a secure procedure.

Moreover, the secure procedure to update this information 31 must make sure that only the authorized authority is capable of performing these updates, for example based on an authenticator calculated with a key shared between the approved authority and the identification module 2.

The protection provided by setting the LOCK indicator appears sufficient in most cases. The following would be necessary to neutralize this protection:

approved mobile terminal would have to be available, in other words matched to a SIM identification module,

the IMEI identification number of the mobile terminal would then have to be obtained, either by a simple manipulation or by observing exchanges between the mobile terminal and the identification module through appropriate means, and

mobile terminal (not approved) accepting a modification to its IMEI number would also have to be available.

This scenario assumes that the user of approved mobile terminal cooperates with the fraudor, which is not realistic.

However, it would be possible to protect read access to files stored by the identification module and containing the identification number(s) of authorized mobile terminal, either by password or by an active signature procedure, in order to prevent the identification module from being matched to an unapproved mobile terminal.

It would also be possible to plan to add identification information for the mobile terminal 1 stored in the module 3 that identifies profile information for mobile terminal 1; in standard 3GPP 31.111, there is a standard “profile download” command that the identification module uses to receive profile information from the mobile terminal about the terminal configuration, and the identification module uses this information to control the mobile terminal. This profile information particularly includes the size of the mobile terminal display screen and information necessary for the “Call Control” function to prevent the mobile terminal from calling some telephone numbers, and including a list of prohibited numbers stored by the identification module.

Once the mobile terminal 1 and the identification module 2 are thus matched, they can execute applications requiring a high security level, for example such as generation of a signature for example applied to a transaction, access to a received encrypted message, and access control to confidential data stored in the mobile terminal.

Obviously the other functions of the mobile terminal remain accessible even if the mobile terminal has not been matched.

When an application requiring a high security level is run on the mobile terminal, it asks the user to input a confidential code on the keyboard that is transmitted in a request to the identification module. When such a request is received, the identification module 2 checks to see if the confidential code input is correct and if the LOCK indicator is set. If either of these checks fails, the identification module returns an error message to the mobile terminal. On reception of such an error message, the application run by the mobile terminal displays the received error report and is terminated. Consequently, the mobile terminal cannot execute an application requiring a high degree of security unless the identification module has recognized the user and unless the identification module is matched with the mobile terminal.

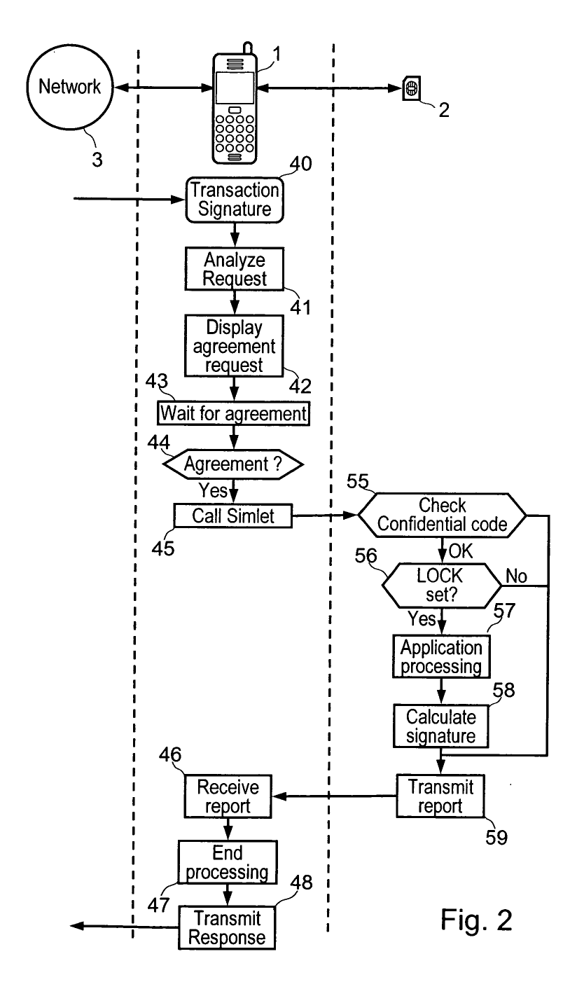

FIG. 2 illustrates a procedure for generating a signature applied to a transaction 40, enabling the user to validate his commitment in the transaction using his mobile terminal 1. This procedure is triggered when the terminal receives a request message containing transaction parameters. In particular, these parameters contain the identity of the other party to the transaction (for example the identity of the vendor in a purchasing transaction), the purpose of the transaction (the nature of the goods or the purchased service) and the amount of the transaction. If it is a gambling game, the request message contains the bet identification, the terms of the bet input by the user and the bet amount. The mobile terminal analyses the request message in step 41 to reproduce the information about the transaction in an intelligible manner, and this information is displayed on the screen of the mobile terminal in step 42.

In step 43, the mobile terminal then prompts the user to give his agreement by inputting a confidential code, and puts itself in waiting for this confidential code. Once this confidential code has been input (step 44), the mobile terminal triggers a verification procedure by the identification module, in step 45. For the module 2, this procedure consists of checking the received confidential code (step 55), and whether or not the LOCK indicator is set (step 56). If these checks are positive, the identification module executes an application processing 57 that depends on what transaction is envisaged. This application processing may for example consist of checking that the requested amount is less than a sliding ceiling over a given period, which assumes that the identification module 2 records and manages a history of transactions carried out. In the next step 58, the identification module calculates a signature that it returns in a report message (step 59). The mobile terminal receives this message in step 46, and terminates the application processing in step 47. If the report message is positive and contains the transaction signature, the mobile terminal transmits a response message to the request message that triggered the procedure 40, in the next step 48 through the network.

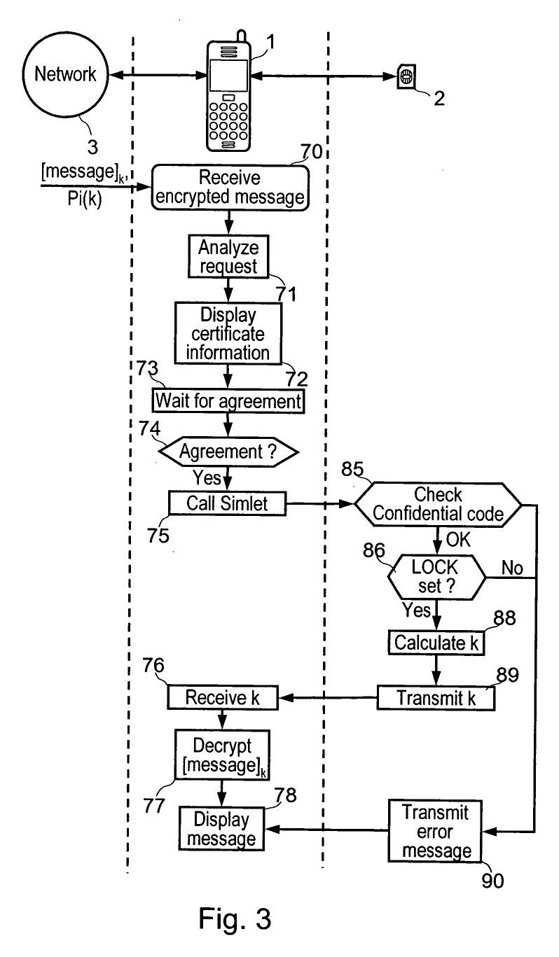

FIG. 3 illustrates a procedure 70 for reception of an encrypted message. This procedure is triggered by reception of an encrypted message containing the message itself [message]ₖ, encrypted using a secret key k and the result Pi(k) of the encryption of the key k using an asymmetric algorithm using a public key Pi belonging to the destination user corresponding to a private key Si memorized by the identification module 2.

This procedure includes a step 71 in which the request is analyzed consisting of making a distinction between the various information contained in the message, namely the encrypted message, and the encrypted key k. This step is followed by a step 72 in which the information in the message header, for example containing the issuer's identity and the purpose of the message, are displayed. In the next step 73, the user is prompted to input his confidential code so that it can be authenticated. When this confidential code is input in step 74, a message containing the input code and the encrypted key k Pi(k) is sent to the identification module 2 which triggers execution of a procedure by the identification module 2, consisting in a first step 85 of checking the confidential code input by the user, and in a second step 86 checking that the LOCK indicator is set. If these checks are positive, the identification module 2 decrypts the key k in the next step 88 using the private key Si that it holds that corresponds to the public key Pi. This decrypted key k is sent to the mobile terminal in step 89 and is received by the mobile terminal in step 76 of procedure 70. In the next step 77, the mobile terminal decrypts the message [message]ₖ using the key k received from the identification module 2, and displays it on the screen (step 78).

If the confidential key input by the user is not correct or if the LOCK indicator is not set, the identification module sends a negative report to the mobile terminal (step 90) indicating the type of error encountered. When the mobile terminal receives this report message, it displays an error message.

The LOCK indicator can also be used to control access to data stored in the memory of mobile terminal 1. For example, it may be personal information or files containing data protected by copyright. Access control to the data is made as a function of the requested access mode, namely for example display or reproduction, modification, copy, transmission, change name or print these data.

In this application for access to data stored by the mobile terminal, each data or file is associated with hierarchical protection levels that depend on access modes, and each user who has a confidential code that is saved in the identification module is associated with an access right level. Thus, for example, level 0 indicates that access to the file is uncontrolled for the corresponding access mode, level 1 indicates that access to the file is only authorized for the access mode corresponding to users with an equivalent or higher access right, etc.

These hierarchical protection levels assigned to files are defined by the mobile terminal holder using a specific security procedure that can only be executed when the mobile terminal is matched (LOCK indicator set) and when the holder is authenticated by the identification module.

Data access is authorized after the user has been authenticated (by confidential code) and after the state of the LOCK indicator has been checked.

Moreover, these files or data can be encrypted. In this case, the identification module decrypts these data when the user has been authenticated correctly and if the LOCK indicator is set.

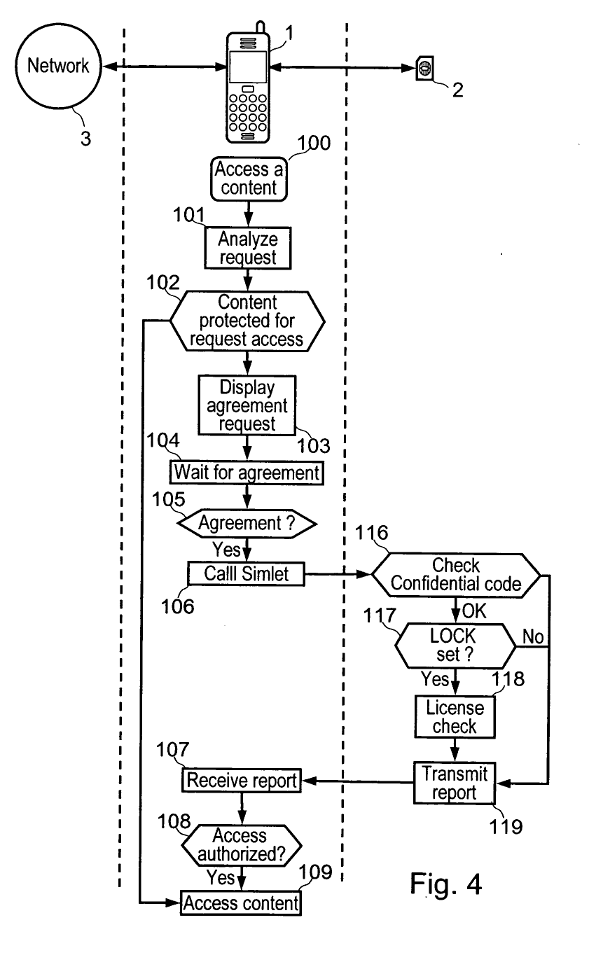

FIG. 4 illustrates a procedure 100 for access control to a content stored in the memory of the mobile terminal 1. This procedure is triggered by the user when he attempts to access content that he has specified.

This procedure comprises a step 101 for analysis of the access request, consisting in particular of determining the required access right level for the file and the access mode to the requested file.

In the next step 102, the mobile terminal tests the required access right level and goes directly onto step 109 to access the requested file if the access right level corresponding to the file and to the access mode does not necessitate that the user's rights should be checked. It may also determine whether or not a license is associated with the file and step 109 will not be started if this is not the case.

If the requested file requires that access rights and/or the license have to be checked, the mobile terminal asks the user to input a confidential code (step 103) and goes into waiting for this confidential code (step 104). When this confidential code has been input (step 105), the mobile terminal triggers a checking procedure through the identification module 2 in step 106, with the confidential code input by the user as a parameter. For module 2, this procedure consists of checking the received confidential code (step 116), and whether or not the LOCK indicator is set (step 117). If these checks are positive, the identification module performs application processing (118) that depends on the content type requested by the user. For example, this application processing may consist of checking a signature of the requested content editor, and/or checking that the access requested by the user is authorized by a license associated with the content, memorized by the identification module. This type of license can thus authorize some access modes, possibly within a limited range of usage dates, or a given number of times.

Note that the mobile terminal can memorize the license. In this case, it is transmitted to the identification module for checking, with the confidential code input by the user.

In the next step 119, the identification module returns an authorization report message that may contain a decryption key allowing access to the contents, as is the case for example for musical or video contents protected by DRM (Digital Rights Management). The mobile terminal receives this message in step 107 and provides access to the contents (step 109), if this access is authorized by the report message (step 108).

In all the application procedures described above, the user may also be authenticated by biometric recognition using a biometric reference (for example a fingerprint) that is input by the user into the mobile terminal, this reference being transmitted to the identification module 2 that compares it with a reference stored in its memory.

Several confidential codes or biometric references may be stored in the identification module, so that several users can use them. In this case, in applications generating an electronic signature or reception of an encrypted message, the private key chosen by the identification module to generate a signature or to decrypt it depends on the identity of the user who will thus have been authenticated.

1. A method for securing a telecommunication terminal when it is connected to a terminal user identification module, said method comprising execution of a matching procedure in which:
the terminal transmits terminal identification information to the identification module connected to the terminal,
the identification module compares the identification information received from the terminal with terminal identification information stored in a memory, and transmits the result of the comparison to the terminal,
if the identification information stored by the identification module corresponds to the identification information stored by the terminal, it sets an internal matching indicator (LOCK) indicating that the terminal has been identified by the identification module, and
if the internal matching indicator (LOCK) is not set by the identification module, the terminal prevents execution of procedures requiring a high degree of security, installed in the terminal, the other functions of the terminal remaining accessible.

2. The securing method according to claim 1, wherein the matching procedure is run every time that the terminal is switched on.

3. The securing method according to either claim 1, wherein if the identification information stored by the identification module does not correspond to the information for the terminal, the terminal triggers a procedure to update the identification information stored by the identification module, in which the identification module previously authenticates an authority approved to perform this update, and if the authentication is successful, the identification module memorizes the received terminal identification information and sets the internal matching indicator.

4. The securing method according to claim 1, wherein the identification module memorizes identification information for several terminals.

5. The securing method according to claim 1, wherein a list or a sequence of terminal identification information is registered in the memory of the identification module when it is submitted to the user.

6. The securing method according to claim 5, further comprising execution of a procedure to update the list or sequence of terminal identification information memorized by the identification module, performed through a data transmission network by an authorized authority, said procedure comprising a step to authenticate the authority authorized by the identification module.

7. The securing method according to claim 1, wherein the terminal identification information includes terminal profile information.

8. The securing method according to claim 1, wherein read access to terminal identification information stored by the identification module is protected either by a password or by an active signature procedure, in order to prevent matching of the identification module to unapproved terminal.

9. The securing method according to claim 1, wherein a procedure requiring a high degree of security is only executed following a step in which the user inputs a confidential code to the terminal, the identification module checks said confidential code, and a procedure requiring a high degree of security is not executed unless the confidential code input by the user is correct.

10. The securing method according to claim 1, wherein procedures requiring a high degree of security include a procedure for generating an electronic signature.

11. The securing method according to claim 1, wherein procedures requiring a high degree of security include a procedure for reception and decryption of an encrypted message using a secret key memorized by the identification module.

12. The securing method according to claim 1, wherein procedures requiring a high degree of security include a procedure for authorization of access to contents stored in the memory of the terminal, each content being associated with access authorization levels as a function of content access modes, an access authorization level being assigned to each terminal user, the access procedure giving a user access to a requested content for an access mode specified by the user only if the user has an access authorization level corresponding to the specified access mode for the requested content.

13. The securing method according to claim 12, wherein some of the contents stored in the terminal memory are associated with a license stored by the identification module or transmitted to the identification module by the terminal, the license being checked by the identification module in order to decide whether or not to authorize access to the associated content.

14. A telecommunication terminal comprising means for connecting an identification module, and means for implementing a method according to claim 1.

15. The telecommunication terminal according to claim 14, wherein the identification module is a chip card, and the connection means includes a connector for a chip card.

16. The telecommunication terminal according to claim 15, wherein said terminal is a mobile terminal.

17. An identification module for telecommunication terminal comprising means for connecting a terminal, and means for implementing the method according to claim 1.

18. The identification module according to claim 17, wherein said module is a chip card provided with means for connecting the chip card to a telecommunication terminal.
